(19) United States
(12) Patent Application Publication
(10) Pub. No.: US 2011/0170491 A1
(43) Pub. Date: Jul. 14, 2011

(54) Communication device and communication method

(75) Inventors: Chiaki Shinohara, Fukuoka (JP); Kazuhisa Obuchi, Kawasaki (JP); Yoshiharu Tajima, Kawasaki (JP); Yoshinori Soejima, Fukuoka (JP); Manabu Kubota, Fukuoka (JP); Miki Yamasaki, Fukuoka (JP); Shinya Okamoto, Fukuoka (JP); Akihide Otonari, Fukuoka (JP)

(73) Assignee: Fujitsu Limited, Kawasaki (JP)

(21) Appl. No.: 13/064,329

(22) Filed: Mar. 18, 2011

Related U.S. Application Data
(63) Continuation of application No. PCT/JP2008/067020, filed on Sep. 19, 2008.

(51) Int. Cl. H04W 40/00

(52) U.S. Cl. 370/328

(57) ABSTRACT

A communication device with a communication protocol including at least two layers includes a data reception unit that receives data transmitted from another communication device; a buffer control unit that rearranges a storage order of data in a buffer based on a number of retransmission times and a retransmission interval of retransmission data, stores the retransmission data in the buffer when the data reception unit has successfully received the retransmitted retransmission data; and a data transfer unit that transfers the data stored in the buffer to an upper layer.

### CROSS-REFERENCE TO RELATED APPLICATION

This application is a continuation of International Application No. PCT/JP2008/067020, filed on Sep. 19, 2008, the entire contents of which are incorporated herein by reference.

### FIELD

The embodiments discussed herein are directed to a communication device and a communication method.

### BACKGROUND

In recent years, a study on a communication specification called a long term evolution (LTE) as a new standard in a wireless communication system has been actively conducted. The LTE attracts attention in a 3rd generation partnership project (3GPP) that is one of communication standardization projects. For example, an improvement of a layer 2 corresponding to a data link layer has been made.

The layer 2 is installed in each user equipment (UE), such as a portable telephone, that performs wireless communication based on the LTE. Specifically, as illustrated in FIG. 1, the layer 2 has three sub-layers: a packet data convergence protocol (PDCP); a radio link control (RLC); and a medium access control (MAC).

A PDCP entity and an RLC entity belonging to the PDCP and the RLC, respectively, exist as many as the number (n in FIG. 8) of logical channels (LCHs) used for wireless communication and have a one-to-one correspondence therebetween.

Each of the n PDCP entities outputs a protocol data unit (PDU) of the PDCP, which is obtained by adding a header of the PDCP to transmission data, to a corresponding RLC entity.

The PDU is converted to a service data unit (SDU) in the RLC. Each RLC entity obtains a PDU of the RLC by adding a header of the RLC. That is, if a PDU of an upper-level sub-layer is output to a lower-level sub-layer, the PDU of the upper-level sub-layer is treated as an SDU of the lower-level sub-layer.

A PDU of the lower-level sub-layer is obtained by adding a header of each sub-layer to an SDU in the lower-level sub-layer.

For example, as illustrated in FIG. 9, when the PDU of the RLC (hereinafter, referred to as “RLC-PDU”) is output from each RLC entity to the MAC, the RLC-PDU is multiplexed. A header (H) of the MAC and a MAC control information are added to the RLC-PDU, so that the RLC-PDU is converted to a PDU of the MAC (hereinafter, referred to as “MAC-PDU”). The MAC-PDU is subjected to a process of a layer 1 corresponding to a physical layer and then transmitted.

At this time, an MAC entity belonging to a transmission side MAC that transmits the MAC-PDU decides an empty space size of the MAC-PDU based on radio resources such as a bandwidth or power that can be used for transmission of data, appropriately allocates the RLC-PDU to an empty space of the MAC-PDU, and performs multiplexing.

The obtained MAC-PDU is transmitted under retransmission control by a hybrid automatic repeat request (HARQ). An MAC entity belonging to a reception side MAC as a side that receives the MAC-PDU analyzes the MAC-PDU received from the transmission side MAC, divides the MAC-PDU into one or more RLC-PDUs, and transmits the RLC-PDU to each RLC.

The RLC entity analyzes the received RLC-PDU, creates the RLC-SDU, and transmits the RLC-SDU to the PDCP.

Data transmission to be performed by the HARQs of the transmission side and the reception side will be described with reference to FIG. 10. In FIG. 10, for convenience, each MAC-CPU is designated as a number (#1, #2, etc.). In the HARQ, retransmission control using an re-channel stop-and-wait is performed.

In the HARQ, as illustrated in FIG. 10, at the time of transmission, the MAC-PDU is retained, and an error correction process and cyclic redundancy check (CRC) coding are also performed on the MAC-PDU.

Then, when a reception result of an MAC-PDU #1 indicates unsuccessful reception (that is, an error detection result using a CRC code indicates “error”), the reception side transmits negative acknowledge (NACK) representing the fact to the transmission side. However, when a reception result of MAC-PDUs #2 and #3 transmitted later from the transmission side indicate “successful reception” (that is, the error detection result using the CRC code indicates “no error”), the reception side transmits ACK representing the fact to the transmission side.

Thereafter, in the transmission side, when NACK is received, the MAC-PDU #1 retained at the time of first transmission is retransmitted, but when ACK is received, the MAC-PDU retained at the time of first transmission is discarded.

The reception side divides the received MAC-PDUs based on a reception order to create the RLC-PDUs and transmits the RLC-PDUs to the upper-level RLC.

Further, even when one MAC-PDU has repetitively been retransmitted at a predetermined maximum number of retransmission times but ACK has not been received, the corresponding MAC-PDU is discarded. For this case, in the RLC, retransmission control is performed by an automatic repeat request (ARQ) using poll/status information.

For example, as illustrated in FIG. 11, in the case of transmitting data corresponding to sequence numbers (hereinafter, referred to as “SN”) 1 to 4 from the RLC at the transmission side to the RLC at the reception side, the RLC at the transmission side sequentially transmits data of SN=1 to SN=4 to the RLC at the reception side. At this time, the RLC at the transmission side adds poll information, that request status information, to data of SN=4 that is lastly transmitted and transmits data of SN=4 to the RLC at the reception side.

Here, the RLC at the reception side first transmits SN=1 to the upper-level PDCP at a point in time when SN=1 is received. Thereafter, at a point in time when the poll information is detected, since data of SN=4 has been received but data of SN=2 and data of SN=3 have not been received, it is recognized that data of SN=2 and data of SN=3 have been missed. Since the RLC at the reception side needs to transmit data to the upper-level PDCP in an SN order, transmission of data to the upper-level PDCP is not performed.

Thereafter, the RLC at the reception side transmits Status-NACK SN=2,3 to the RLC at the transmission side as the status information representing that data of SN=2 and data of SN=3 could not be received. When the status information is received, the RLC at the transmission side retransmits data of SN=2 and data of SN=3 that have not been received by the RLC at the reception side. At this time, the RLC at the transmission side adds poll information to data corresponding to SN=3 and transmits data of SN=3.

Here, if the RLC at the reception side has received data of SN=3 but has not received data of SN=2, at a point in time when the poll information is received, since data of SN=2 has not been received, the RLC at the reception side transmits the status information (Status-NACK SN=2) representing the fact to the RLC at the transmission side.

At this time, since data of SN=3 has been received later than data of SN=4, the RLC at the reception side rearranges data of SN=3 and data of SN=4.

When the Status-NACK SN=2 is received, the RLC at the transmission side adds poll information to data of SN=2 and retransmits data of SN=2. When data of SN=2 is received, the RLC at the reception side transmits status information (Status-ACK SN=4) representing the fact to the RLC at the transmission side.

The RLC at the reception side rearranges data so that data of SN=2 received lastly can be positioned at the first place and then transmits data of SN=2 to 4 to the upper-level PDCP.

Japanese Laid-open Patent Publication No. 2007-281808 discloses a packet communication device. In this packet communication device, arriving packets are retained in a buffer for packet data rearrangement and rearranged in an order. When a packet does not arrive within a certain time period, normal reception by rearrangement is given up, and timer control entrusted to retransmission in an upper-level layer is performed. The number of retransmission times of a non-received packet that starts when a discontinuous reception waiting status occurs is counted. When the number of retransmission times counted by a retransmission counter reaches a predetermined number of retransmission times, the reception waiting status is given up, and already received packets are transmitted to the upper-level layer.

Further, Japanese National Publication of International Patent Application No. 2008-527943 discloses a packet data transmission method. In this packet data transmission method, in a mobile communication system in which packet transmission can be performed using a HARQ scheme, a base station receives a PDU from a terminal and determines whether or not a retransmission number representing the retransmission times can be calculated. When the RSN of the PDU cannot be calculated, the base station sets a specific value, which represents that the number of retransmission times of the PDU cannot be known, as the RSN. The base station transmits the set RSN to a serving radio network controller (SRNC) together with the PDU.

Non-patent Document: 3GPP, TS36.300 “Evolved Universal Terrestrial Radio Access (E-UTRA) and Evolved Universal Terrestrial Radio Access (E-UTRAN); Overall description; Stage 2” http://www.3gpp.org/ftp/Specs/archive/36_series/36.300/3630 0-850.zip

However, in the communication device having the layer 2 described above, the MAC at the reception side may receive data in an order different from a transmission order of the MAC at the transmission side due to the retransmission process performed by the HARQ of the transmission side. In this case, there was a possibility that a processing load of the RLC at the reception side would increase.

Here, a case in which the MAC at the reception side receives data in an order different from a transmission order of the MAC at the transmission side will be described with reference to FIG. 12. In FIG. 12, for convenience, data (MAC-PDU) to be transmitted by the HARQ of the transmission side is labeled as a number (#1, #2, etc.). Further, in a description using FIG. 12, the HARQ at the transmission side is referred to as a transmission side, and the HARQ of the reception side is referred to as a reception side.

As illustrated in FIG. 12, when the transmission side has transmitted data in an order of #1 to #n, if the error detection result using the CRC code on data of #1 in the reception side indicates “unsuccessful reception”, the reception side transmits NACK to the transmission side.

Subsequently, the reception side sequentially receives data of #2 and data of #3. If the error detection result using the CRC code on the received data indicates “successful reception”, the reception side sequentially transmits data of #2 and data of #3 to an upper-level RLC.

Thereafter, the transmission side that has received NACK from the reception side retransmits data of #1 to the reception side. If the error detection result using the CRC code on the retransmitted data of #1 indicates “successful reception”, the reception side transmits the received data of #1 to the upper-level RLC. In this case, data of #2 and data of #3 that have been transmitted later from the transmission side are transmitted to the upper-level RLC prior to data of #1 that has been transmitted prior to them.

When the reception side receives data in an order extremely different from a transmission order of the transmission side, in the upper-level RLC at the reception side, a process load of rearranging an order of data according to the transmission order of the transmission side increases.

Further, as described above, when data that should be received has not been received, the RLC transmits a retransmission request of the data to the RLC at the transmission side by the ARQ using the poll/status information. The RLC receives the retransmitted data, rearranges the data in the transmission order of the RLC at the transmission side, and transmits the data to the PDCP. However, since it is impossible to detect whether or not retransmission by the HARQ is being performed on each data, the HARQ may transmit Status-NACK, twice, on data in which NACK has been transmitted.

In this case, the RLC not only transmits unnecessary Status-NACK but also receives the same data later twice, and thus the processing load increases.

The increase in processing load in the RLC at the reception side may be problematic even in an LTE-advanced that is an expanded version of the LTE that is recently being studied as well as conventional data transmission between communication devices.

In the LTE-advanced, it is anticipated that a relay station (RS) 300a that relays data transmission between a base station (eNB) 100a and each user equipment (UE) will be introduced into as illustrated in FIG. 13. In FIG. 13, an area defined by a dotted line (2) is an area into which the RS is introduced, and an area defined by a dotted line (1) is a conventional area into which the RS is not introduced.

In the case in which the RS 300a is introduced, it is under consideration that as protocols, three sub-layers (MAC, RLC, and PDCP) disposed in the conventional layer 2 are implemented in the eNB 100a and a UE 200a, and the MAC is implemented in the RS 300a at both the transmission side and the reception side, as illustrated in FIG. 14. Further, it is under consideration that a relay buffer that temporarily stores data for retransmission by the HARQ is implemented between both MACs of the RS 300a. In FIG. 14, the PDCPs of the eNB 100a and the UE 200a are omitted.

In the case in which such a communication system is constructed, when data transmission from the eNB 100a to the UE 200a is performed, the retransmission process by the HARQ is performed in two places between the eNB 100a and the RS 300a and between the RS 300a and the UE 200a.

For this reason, at the time of data transmission from the eNB 100a to the RS 300a, due to the retransmission process of the HARQ, the RS 300a receives data in an order different from a transmission order of the eNB 100a. Since the RS 300a does not include the RLC that performs data order control, data is retained in the RS buffer in a reception order.

Thereafter, when the UE 200a receives data, due to the retransmission process of the HARQ at the time of data transmission from the RS 300a to the eNB 100a, an order of data further changes. Thus, in the RLC of the UE 200a, the processing load for changing the data order increases, so that data transmission may be delayed or an unnecessary transmission request may be made.

### SUMMARY

According to an aspect of an embodiment of the invention, a communication device with a communication protocol including at least two layers includes a data reception unit that receives data transmitted from another communication device; a buffer control unit that rearranges a storage order of data in a buffer based on a number of retransmission times and a retransmission interval of retransmission data, stores the retransmission data in the buffer when the data reception unit has successfully received the retransmitted retransmission data; and a data transfer unit that transfers the data stored in the buffer to an upper layer.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an explanation diagram illustrating a configuration of a UE according to a first embodiment;

FIG. 2 is an explanation diagram illustrating storage order control of data performed by a MAC buffer control unit according to the first embodiment;

FIG. 3 is an explanation diagram illustrating storage order control of data performed by the MAC buffer control unit according to the first embodiment;

FIG. 4 is a flowchart illustrating a process executed by a MAC according to the first embodiment;

FIG. 5 is an explanation diagram illustrating a configuration of an RS according to a second embodiment;

FIG. 6 is an explanation diagram illustrating the flow of data when a UE receives data from an eNB through an RS according to the second embodiment;

FIG. 7 is a flowchart illustrating a process executed by an RS MAC according to the second embodiment;

FIG. 8 is an explanation diagram illustrating a configuration of a conventional layer 2;

FIG. 9 is an explanation diagram illustrating data creation and transmission and reception of data performed by a conventional layer 2;

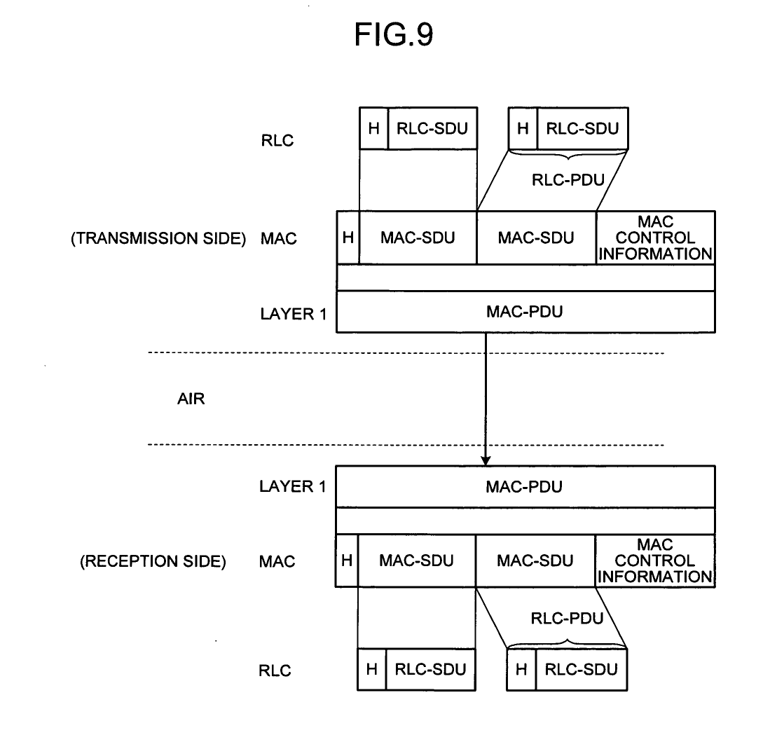

FIG. 10 is an explanation diagram illustrating an example of data retransmission control performed by a conventional HARQ;

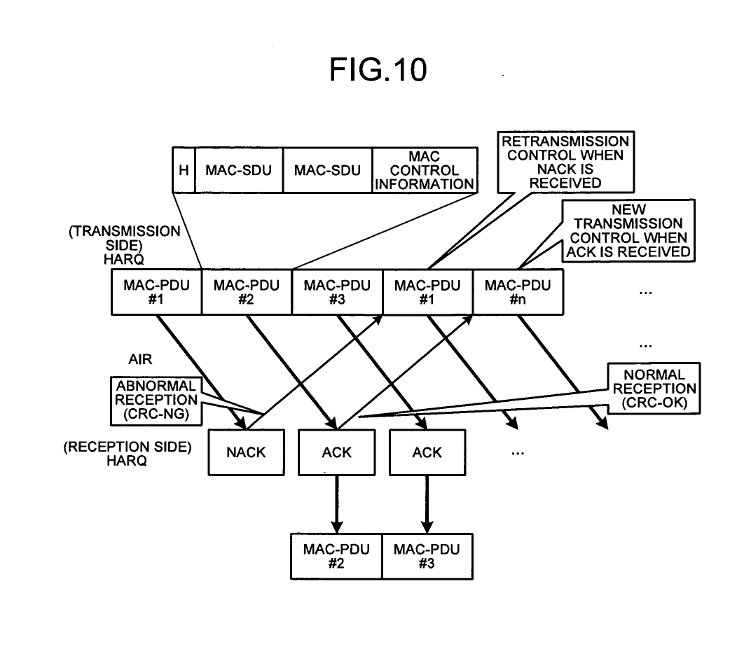

FIG. 11 is an explanation diagram illustrating an example of data retransmission control performed by a conventional RLC;

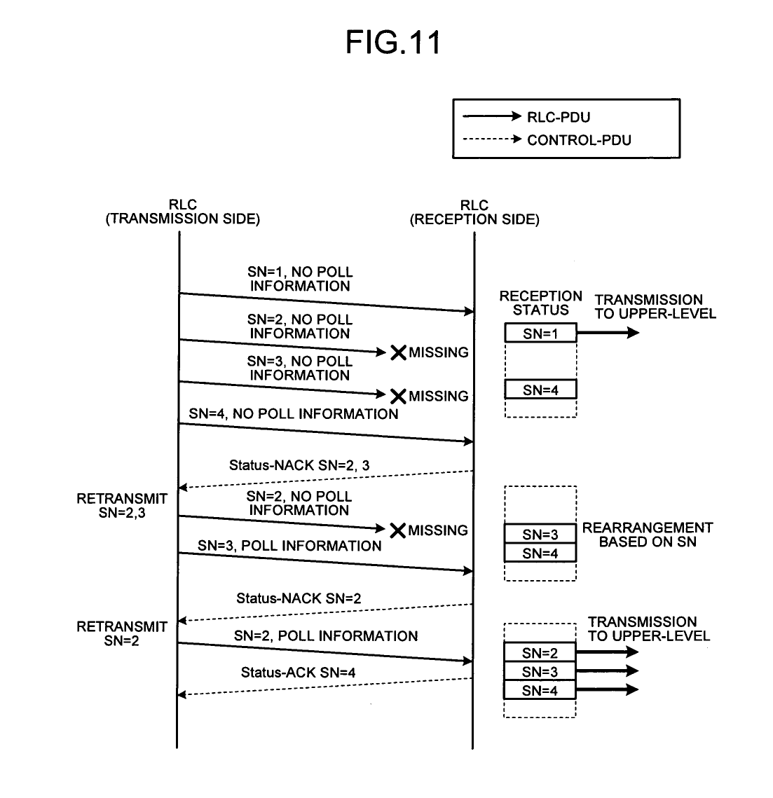

FIG. 12 is an explanation diagram illustrating an example of data transmission to a RLC by a conventional MAC;

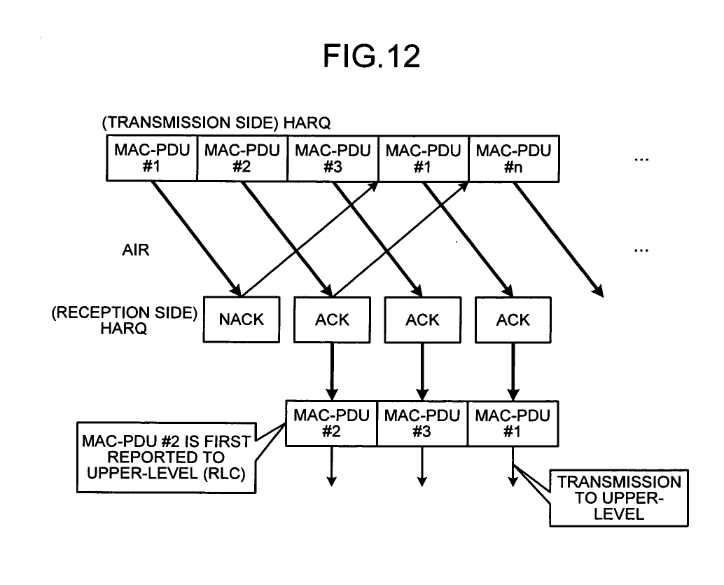

FIG. 13 is an explanation diagram illustrating a communication system into which an RS is introduced; and

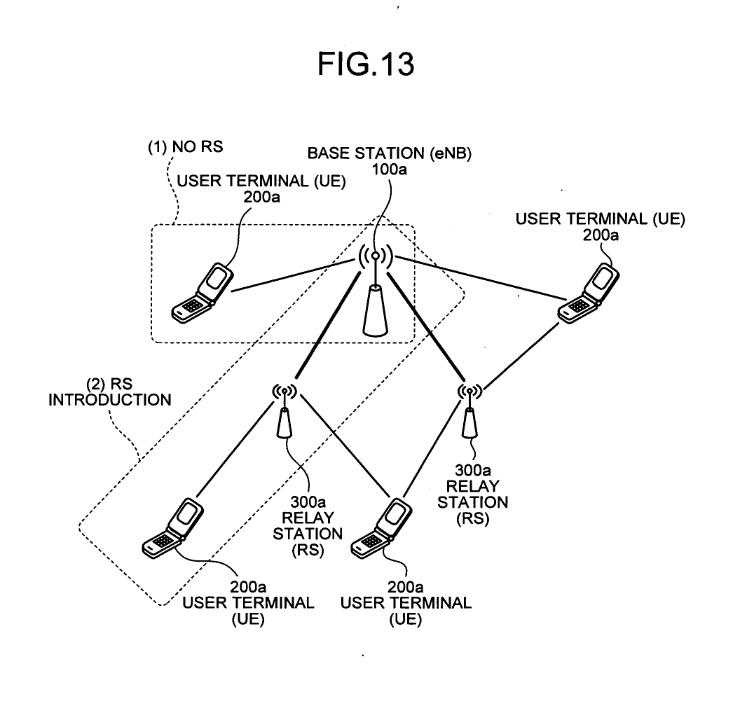

FIG. 14 is an explanation diagram illustrating the flow of data when a UE receives data from an eNB through a conventional RS.

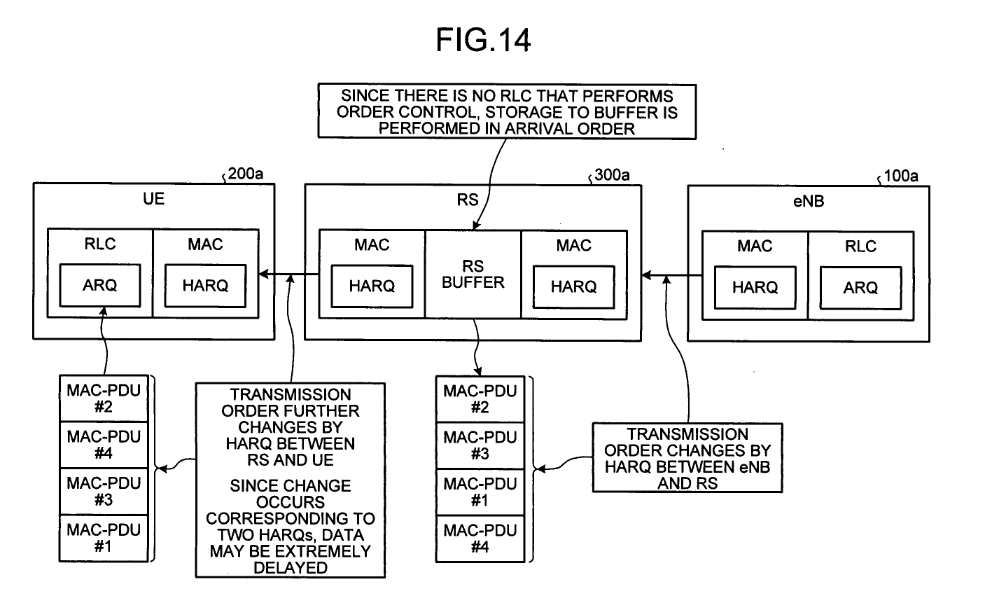

### DESCRIPTION OF EMBODIMENTS

Preferred embodiments of the present invention will be explained with reference to accompanying drawings. The first embodiment will be described in connection with a case in which the present invention is applied to user equipment (hereinafter, referred to as “UE 200”) such as a portable telephone that mutually perform transmission and reception of data through a base station (hereinafter, referred to as “eNB 100”). The second embodiment will be described in connection with a case in which the present invention is applied to a relay station (hereinafter, referred to as “RS 300”) that relays data between the UE 200 and the eNB 100.

### [a] First Embodiment

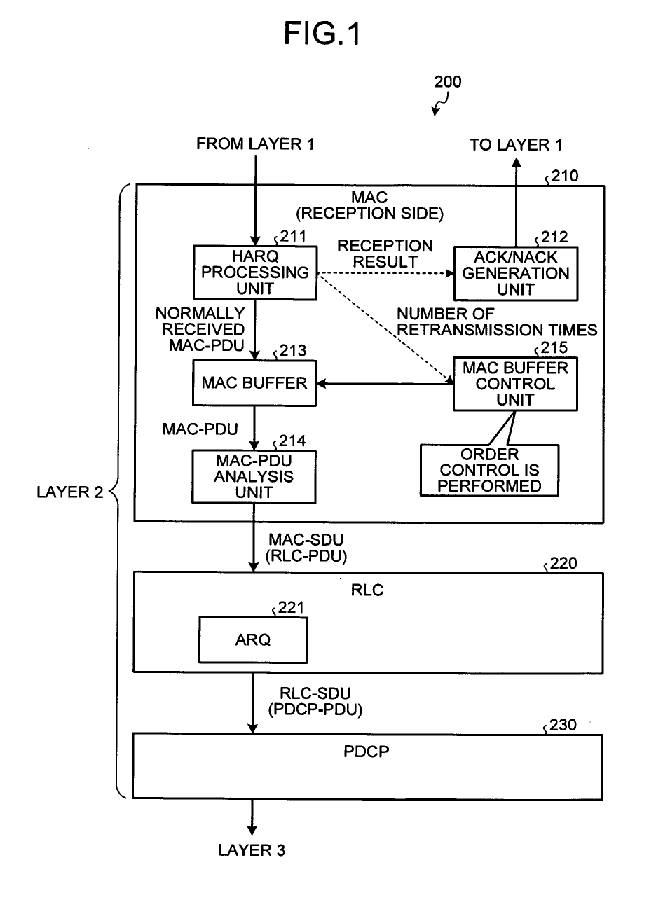

As illustrated in FIG. 1, the UE 200 according to the first embodiment includes a layer 2 corresponding to a data link layer in a communication specification called the LTE. The layer 2 includes three sub-layers: a MAC 210; an RLC 220; and a PDCP 230.

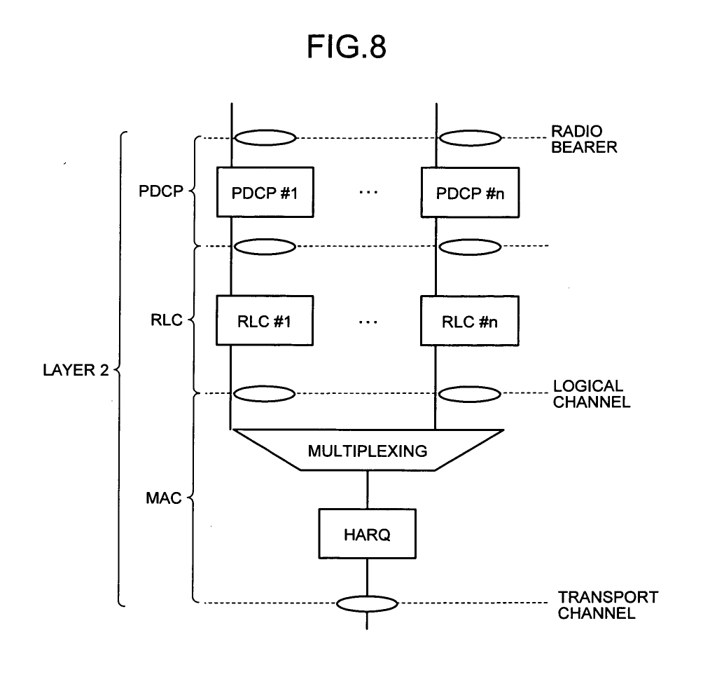

A configuration and an operation of the PDCP 230 and the RLC 220 are the same as those of the conventional PDCP and RLC illustrated in FIG. 8 and thus are here simply described. The PDCP 230 extracts a PDCP-SDU from a PDCP-PDU received from the RLC 220 and then transmits the PDCP-SDU to a layer 3.

Further, the RLC 220 divides an RLC-PDU received from the MAC 210 into a plurality of RLC-SDUs and transmits the RLC-SDUs to the PDCP 230. The RLC 220 includes an ARQ 221. When data is received from the eNB 100 through the MAC 210, the RLC 220 receives data, which has failed to be received, from the eNB 100 again by transmitting/receiving the poll/status information to/from the eNB 100, performs a process of rearranging the received data in a transmission order of the eNB 100 (an order of a sequence number when data is transmitted from the eNB 100: hereinafter, referred to as “predetermined order”), and then transmits the data to the PDCP 230.

Particularly, in the layer 2 disposed in the UE 200 of the first embodiment, the MAC 210 is configured to reduce the processing load occurring when the RLC 220 rearranges data.

As illustrated in FIG. 1, the MAC 210 includes a HARQ processing unit 211, an ACK/NACK generating unit 212, a MAC buffer 213, a MAC-PDU analysis unit 214, and a MAC buffer control unit 215.

The HARQ processing unit 211 functions as a data reception unit that receives data (MAC-PDU) that is transmitted from the eNB 100 in the predetermined order. The HARQ processing unit 211 acquires a CRC code added to the received data from the data and outputs a reception result, which represents whether an error detection result using the CRC code indicates “successful reception” or “unsuccessful reception”, to the ACK/NACK generation unit 212. At this time, the data received by the HARQ processing unit 211 includes a sequence number assigned when the eNB 100 transmits data.

When the error detection result using the CRC code on the received data indicates “successful reception” (when the data has been received successfully), the HARQ processing unit 211 stores the normally received data (MAC-PDU) in the MAC buffer. Further, the HARQ processing unit 211 outputs the number of retransmission times of the normally received data, performed by the eNB 100, to the MAC buffer control unit 215.

As a method of acquiring the number of retransmission times of the received data, performed by the eNB 100, through the HARQ processing unit 211, for example, the number of retransmission times may be included in a header of data when the eNB 100 transmits the data, and the HARQ processing unit 211 may acquires the number of retransmission times of the data from the header when the data is received. Further, regardless of the detection result of the CRC code, the HARQ processing unit 211 may store a time or timing when the data is received and calculate the number of retransmission times of the received data based on the time or timing. That is, an arbitrary method may be used.

When the reception result input from the HARQ processing unit 211 indicates “successful reception”, the ACK/NACK generation unit 212 generates ACK representing the fact and transmits ACK to the eNB 100 that is a transmission source of data. However, when the reception result input from the HARQ processing unit 211 indicates “unsuccessful reception” (data has failed to be received), the ACK/NACK generation unit 212 generates NACK representing the fact and transmits NACK to the UE that is a transmission source of data to request retransmission of the data.

The MAC buffer 213 is a storage device that temporarily stores data received from the eNB 100 under control of the HARQ processing unit 211 and the MAC buffer control unit 215. Data stored in the MAC buffer 213 is output to the MAC-PDU analysis unit 214 of a subsequent stage according to control of the MAC buffer control unit 215.

The MAC-PDU analysis unit 214 analyzes data (MAC-PDU) input from the MAC buffer 213, divides the data into a plurality of MAC-SDUs, and then transmits the MAC-SDUs to the RLC.

When data that has failed to be received by the HARQ processing unit 211 (that the error detection result using the CRC code has indicated “unsuccessful reception”) is retransmitted from the eNB 100 and the HARQ processing unit 211 has successfully received the retransmitted retransmission data (the error detection result using the CRC code has indicated “successful reception”), the MAC buffer control unit 215 performs order control so that the storage order of data in the MAC buffer 213 can be rearranged according to the predetermined order in which the eNB 100 has first performed transmission, that is, an order of a sequence number in which the eNB 100 transmits data by storing the retransmission data in the MAC buffer 213 as data received in the predetermined order in which the eNB 100 has first performed transmission, based on the number of retransmission times and a retransmission interval of the retransmission data that has been successfully received.

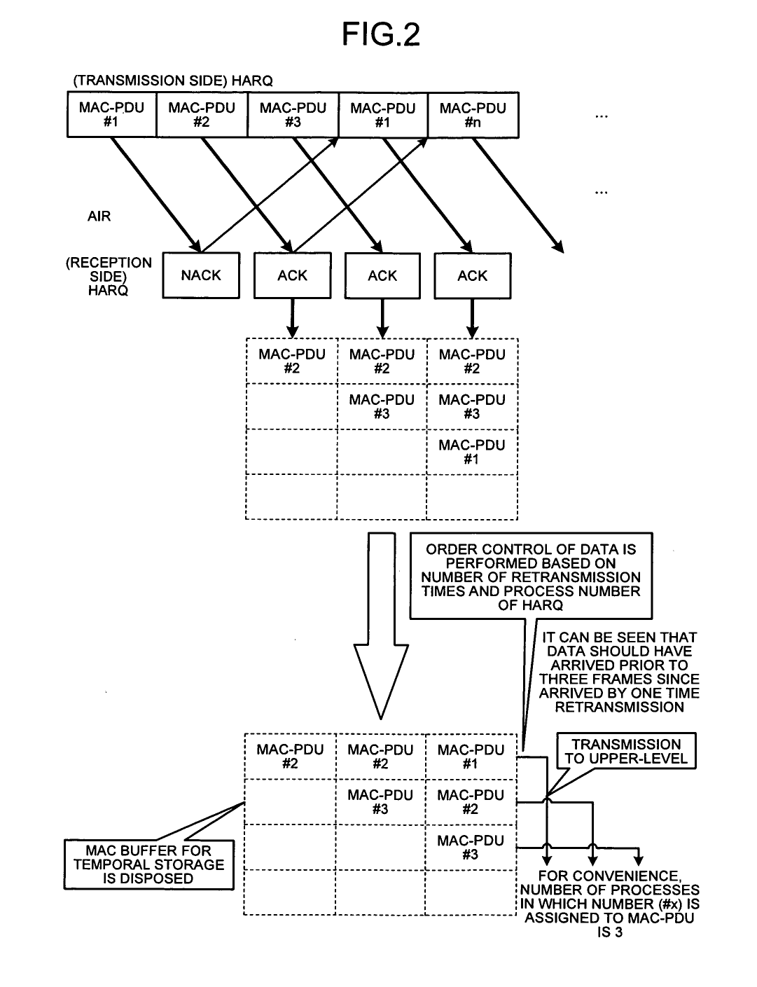

Here, transmission and reception of data performed between the HARQ processing unit 211 at the reception side disposed in the UE 200 of the first embodiment and the HARQ processing unit at the transmission side disposed in the eNB 100, and storage order control of data performed by the MAC buffer control unit 215 will be described in detail with reference to FIG. 2.

Here, the HARQ processing unit at the transmission side is referred to a transmission side HARQ, and the HARQ processing unit 211 at the reception side is referred to as a reception side HARQ 211. Further, a description will be made in connection with a case in which a round trip time (RTT) of ACK/NACK that is transmitted and received between the transmission side HARQ and the reception side HARQ 211 is set to a time interval for transmitting three MAC-PDUs (a time interval for transmitting data of three frames).

Under such setting, when data has not been normally received after the data has been transmitted, the transmission side HARQ performs a process of transmitting three data, including first transmission, and then retransmits data that has not been received. That is, the number of processes from transmission of data to retransmission of the data is always three processes, and a time interval at which the three processes are executed becomes a retransmission time interval of retransmission data.

In FIG. 2, in order to discriminate each data (MAC-PDU), for convenience, each data is labeled as a number (#1, #2, etc.). Further, in a description using FIG. 2, a MAC-PDU labeled as #1 is referred to as data of #1, and the same manner is applied even on #1, #2, and #n.

It is assumed that the transmission side HARQ transmits each data in a predetermined order of #1, #2, and #3 to #n as illustrated in FIG. 2. At this time, when the reception side HARQ 211 fails to receive data of #1, the ACK/NACK generation unit 212 at the reception side transmits NACK to the transmission side HARQ.

Thereafter, when the reception side HARQ 211 successfully receives data of #2, the ACK/NACK generation unit 212 at the reception side transmits ACK to the transmission side HARQ. Here, the MAC buffer control unit 215 stores the received data of #2 in a first storage area of the MAC buffer 213.

Next, when the reception side HARQ successfully receives data of #3, the ACK/NACK generation unit 212 at the reception side transmits ACK to the transmission side HARQ. Here, the MAC buffer control unit 215 stores the received data of #3 in a second storage area of the MAC buffer 213. That is, when the reception side HARQ 211 continues to successfully receive data that has not been retransmitted, the MAC buffer control unit 215 performs control for storing the data in the MAC buffer 213 in an order in which the transmission side HARQ has performed transmission.

Next, since transmission of data corresponding to three frames of #1, #2, and #3 including transmission of data of #1 has been performed (a data transmission process corresponding to the three processes has been executed), the transmission side HARQ receives NACK related to the data of #1 from the ACK/NACK generation unit 212 at the reception side.

When NACK is received, the transmission side HARQ retransmits data of #1. Here, when the reception side HARQ 211 successfully receives data of #1, if the order control is not performed by the MAC buffer control unit 215, data of #1 is stored in a storage area next to data of #3 as illustrated in the middle portion of FIG. 2. However, in the UE 200 of the present embodiment, since data is rearranged by the order control of the MAC buffer control unit 215, data of #1 is stored in a first storage area of the MAC buffer 213 as illustrated in the lower portion of FIG. 2.

In order to perform the order control, the MAC buffer control unit 215 of the present embodiment is configured to acquire the number of retransmission times of data performed by the eNB 100 from the reception side HARQ 211 when the reception side HARQ 211 successfully has performed reception.

Further, when the reception side HARQ 211 successfully receives the retransmitted data, the MAC buffer control unit 215 determines an order in which the data has first been transmitted from the eNB 100 based on the number of retransmission times of the data and a previously set process number as described above and rearranges data in the MAC buffer 213.

Here, since the number of retransmission times of data of #1 is one, the MAC buffer control unit 215 determines the data as data that should have been received prior to three processes (=the number of retransmission times (one time)×the process number(3)). The MAC buffer control unit 215 rearranges a storage order of data in the MAC buffer 213 to a predetermined order in which data has first been transmitted from the eNB 100 by storing data of #1 that is received this time in a storage area, corresponding to an order (first) ahead of data of #2, that is three frames prior.

As a result, in the MAC buffer 213, data received from the eNB 100 is rearranged in a predetermined order in which the eNB 100 has performed transmission. Each data that is rearranged in an order and stored in the MAC buffer 213 is then transmitted to the upper-level RLC 220.

As described above, in the UE 200 of the first embodiment, data received from the eNB 100 by the reception side HARQ 211 in the MAC 210 is rearranged in a predetermined order in which the eNB 100 has first performed transmission and thereafter transmitted to the upper-level RLC 220. Thus, the processing load occurring when the RLC 220 rearranges data is reduced. Further, according to the UE 200, by reducing the processing load of the RLC 220, efficiency of data transmission can be improved.

The example illustrated in FIG. 2 has been described in connection with the case in which the MAC buffer control unit 215 performs the order control of data in the MAC buffer 213 based on the number of retransmission times of data and the previously set process number. However, the MAC buffer control unit 215 may be configured to perform the order control of data in the MAC buffer 213 based on process information of data transmitted from the transmission side HARQ. Here, the process information refers to information that becomes an index for determining a transmission order of data of the eNB 100 based on a timing when the UE 200 successfully receives data from the eNB 100 (for example, a time) or a timing when the UE 200 fails to receive data from the eNB 100 (for example, a time). The process information is information different from the sequence number. That is, the HARQ processing unit of the eNB 100 transmits each data based on predetermined process information different from the sequence information when transmitting data and performs retransmission at a predetermined time interval on data of the same process information when retransmitting data corresponding to the received NACK. For this reason, when the retransmitted data is successfully received, the UE 200 that has received the retransmission data can determine the process information of the retransmitted data and determine a transmission order of the eNB 100 based on a reception timing of data at that time (for example, a time or the number of clocks counted during a retransmission interval).

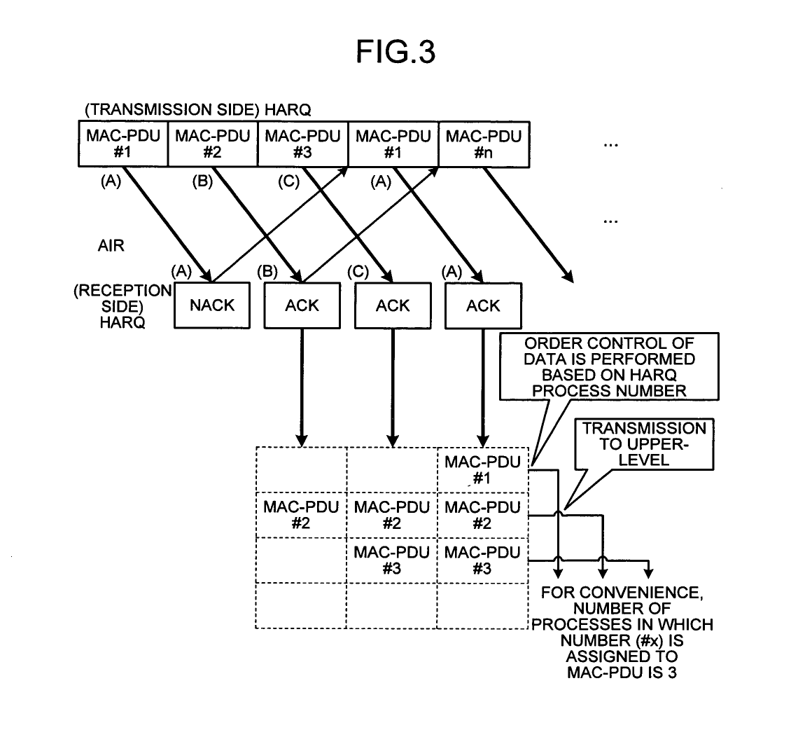

Here, a case in which the MAC buffer control unit 215 performs the order control of data in the MAC buffer 213 based on the process information of data transmitted from the transmission side HARQ will be described with reference to FIG. 3.

Even in the example illustrated in FIG. 3, similarly to the example illustrated in FIG. 2, it is assumed that a round trip time of ACK/NACK transmitted and received between the transmission side HARQ and the reception side HARQ 211 is set to a time interval for transmitting the three MAC-PDUs. Even in FIG. 3, in order to discriminate each data (MAC-PDU), for convenience, each data is labeled as a number (#1, #2, etc.).

The transmission side HARQ transmits data of #1 to #n in a predetermined order as illustrated in FIG. 3. At this time, the transmission side HARQ transmits each data based on the process information representing an order in which data is transmitted.

Here, a description will be made in connection with a case in which the HARQ at the transmission side transmits data of #1 based on a process number (A) as the process information, transmits data of #2 based on a process number (B) as the process information, and transmits data of #3 based on a process number (C) as the process information.

First, the transmission side HARQ transmits data of #1 through the data transmission process of the process number (A). At this time, when the reception side HARQ 211 fails to receive data of #1, the ACK/NACK generation unit 212 at the reception side transmits NACK to the transmission side HARQ.

The HARQ 211 at the reception side determines that the process number of data of #1 that has failed to be received is (A) based on a reception timing (time) of data of #1 that has failed to be received and outputs the process number (A) to the MAC buffer control unit 215. The MAC buffer control unit 215 acquires the process number (A) of data of #1 from the reception side HARQ 211 and stores the process number (A) as the process number of data that has failed to be received.

Next, the transmission side HARQ transmits data of #2 through the data transmission process of the process number (B). Here, when the reception side HARQ 211 successfully receives data of #2, the ACK/NACK generation unit 212 at the reception side transmits ACK to the transmission side HARQ.

At this time, the reception side HARQ 211 determines that the process number of data of #2 that has successfully been received is (B) based on a reception timing (time) of data of #2 and outputs the process number (B) to the MAC buffer control unit 215. Here, the MAC buffer control unit 215 acquires and stores the process number (B) of data of #2 from the reception side HARQ 211 and stores data of #2 in a first storage area in the MAC buffer 213 in association with the process number (B).

Next, the transmission side HARQ transmits data of #3 through the data transmission process of the process number (C). Here, when the reception side HARQ 211 successfully receives data of #3, the ACK/NACK generation unit 212 at the reception side transmits ACK to the transmission side HARQ.

At this time, the reception side HARQ 211 determines that the process number of data of #3 that has successfully been received is (C) based on a reception timing (time) of data of #3 and outputs the process number (C) to the MAC buffer control unit 215. Here, the MAC buffer control unit 215 acquires and stores the process number (C) of data of #3 from the reception side HARQ 211 and stores data of #3 in a (second) storage area next to data of #2 in the MAC buffer 213 in association with the process number (C).

Next, since NACK is received from the reception side HARQ 211 according to a round trip time, the transmission side HARQ retransmits data of #3 through the data transmission process of the process number (A). Here, when the reception side HARQ 211 successfully receives data of #1, the ACK/NACK generation unit 212 at the reception side transmits ACK to the transmission side HARQ.

At this time, the reception side HARQ 211 determines that the process number of data of #1 that has successfully been received is (A) based on a reception timing (time) of retransmitted data of #1 and outputs the process number (A) to the MAC buffer control unit 215.

The MAC buffer control unit 215 acquires the process number (A) of data of #1 from the reception side HARQ 211. Here, by determining a storage order of data of #1 based on the previously stored process numbers (A), (B), and (C) and the process number (A) acquired this time and storing data of #1 in a first storage area ahead of the storage area of data corresponding to the process number (B), the MAC buffer control unit 215 rearranges a storage order of data in the MAC buffer 213 to the predetermined order in which the eNB 100 has first transmitted data.

As a result, in the MAC buffer 213, data received from the eNB 100 is rearranged in the predetermined order in which the eNB 100 has performed transmission. Each data that is rearranged in an order and stored in the MAC buffer 213 is then transmitted to the upper-level RLC 220.

As described above, in the UE 200 of the first embodiment, data received from the eNB 100 by the reception side HARQ 211 in the MAC 210 is rearranged in the predetermined order in which the eNB 100 has first performed transmission and thereafter transmitted to the upper-level RLC 220. Thus, the processing load occurring when the RLC 220 rearranges data is reduced. Further, according to the UE 200, by reducing the processing load of the RLC 220, efficiency of data transmission can be improved.

Further, in the UE 200 of the first embodiment, when a predetermined time elapses after the reception side HARQ 211 receives data, regardless of whether or not the order control is performed so that the storage order of data in the MAC buffer 213 can be changed to a predetermined transmission order of the eNB 100, the MAC buffer control unit 215 transmits each data stored in the MAC buffer 213 to the RLC 220 through the MAC-PDU analysis unit 214.

However, in view of the maximum number of retransmission times of data previously set to the transmission side HARQ, a time until at least data that has failed to be received is transmitted the maximum number of retransmission times is used as the predetermined time, and the MAC buffer control unit 215 is configured to transmit each data stored in the MAC buffer 213 to the RLC 220 when the predetermined time elapses.

As a result, since a time required for the storage order control of data performed by the MAC buffer control unit 215 does not unnecessarily increase, the data transmission efficiency can be prevented from deteriorating.

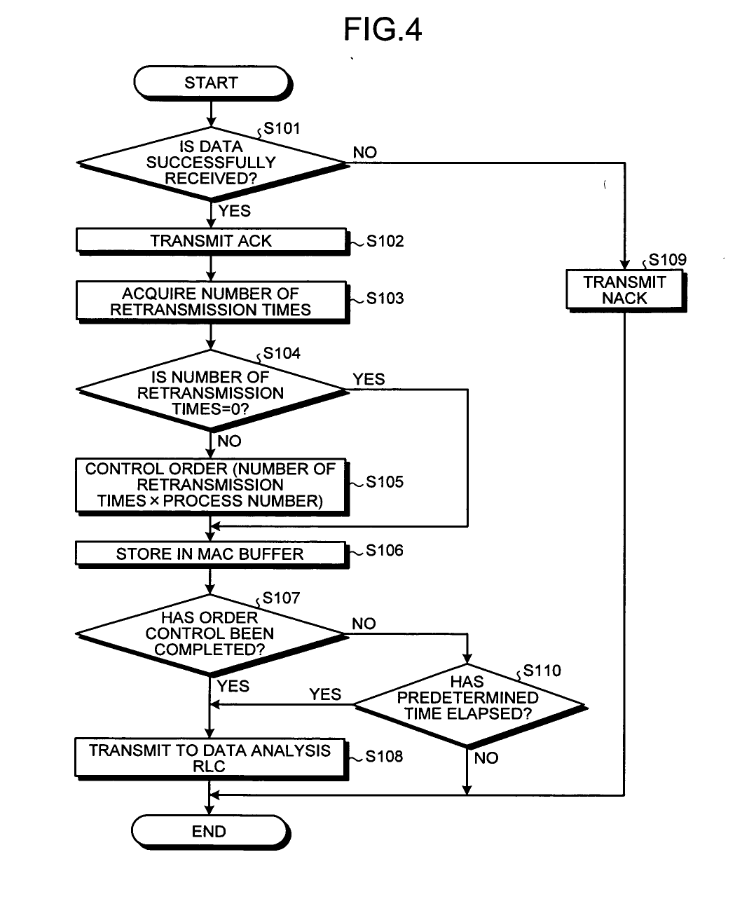

Here, a process to be executed in the MAC 210 of the UE 200 will be described with reference to FIG. 4 in connection with a case in which the MAC buffer control unit 215 performs the order control on the storage order of data in the MAC buffer 213 based on the number of retransmission times of data successfully received by the reception side HARQ 211 and the previously set process number. Each process described below is a process implemented such that a central processing unit (CPU) of a computer disposed in the UE 200 reads out a communication program according to the present embodiment from a read only memory (ROM) and executes the communication program using a random access memory (RAM) as a working area.

When data is transmitted from the eNB 100, as illustrated in FIG. 4, the MAC 210 determines whether or not the HARQ processing unit 211 has successfully received data (step S101). When it is determined that reception has been failed (No in step S101), the ACK/NACK generation unit 212 transmits NACK to the transmission side eNB 100 (step S109), and the process is finished.

However, when it is determined that the HARQ processing unit 211 has successfully received data (Yes in step S101), the ACK/NACK generation unit 212 transmits ACK to the transmission side eNB 100 (step S102), and then the MAC buffer control unit 215 acquires the number of retransmission times of successfully received data from the HARQ processing unit 211 (step S103).

Next, the MAC buffer control unit 215 determines whether or not the acquired number of retransmission times of data is zero (0) (step S104). When it is determined that the number of retransmission times is zero (0) (Yes in step S104), the process proceeds to step S106.

However, when it is determined that the number of retransmission times is not zero (0) (No in step S104), the MAC buffer control unit 215 performs the order control for rearranging the storage order of data in the MAC buffer 213 on data successfully received this time (step S105). Here, as described above, the MAC buffer control unit 215 multiplies the number of retransmission times of data by the process number to decide the storage order of data successfully received this time.

Thereafter, the MAC buffer control unit 215 stores data received this time in the MAC buffer 213 (step S106).

Here, the MAC buffer control unit 215 determines whether or not the order control has been completed (step S107). At this time, when the storage order of data stored in the MAC buffer 213 is changed to the predetermined transmission order in which the transmission side eNB 100 has first performed transmission, the MAC buffer control unit 215 determines that the order control has been completed.

Then, when the MAC buffer control unit 215 determines that the order control has been completed (Yes in step S107), the MAC-PDU analysis unit 214 transmits data stored in the MAC buffer 213 to the RLC 220 (step S108), and the process is finished.

However, when the MAC buffer control unit 215 determines that the order control has not been completed (No in step S107), it is determined whether or not a predetermined time has elapsed (step S110). Here, if data successfully received this time is retransmission data, the MAC buffer control unit 215 determines whether or not a predetermined time has elapsed since first reception of the data has failed. However, if data successfully received this time is not retransmission data, the MAC buffer control unit 215 determines whether or not a predetermined time has elapsed since data has been received.

Then, when the MAC buffer control unit 215 determines that the predetermined time has elapsed (Yes in step S110), the MAC-PDU analysis unit 214 transmits data stored in the MAC buffer 213 to the RLC 220 (step S108), and the process is finished. However, when the MAC buffer control unit 215 determines that the predetermined time has not elapsed (No in step S110), the process is finished “as is”.

Further, when the MAC buffer control unit 215 performs the order control on the storage order of data in the MAC buffer 213 based on the process information of data successfully received by the reception side HARQ 211, the MAC buffer control unit 215 executes a process of acquiring the process information instead of the process of step S103 (number of retransmission times acquisition) in FIG. 4. In this case, the process of step S104 illustrated in FIG. 4 is omitted, and the order control based on the process information is executed as the process of the order control in step S105.

### [b] Second Embodiment

Next, a second embodiment of the present invention will be described. Here, a case in which the present invention is applied to the RS 300 that relays data between the UE 200 and the eNB 100 will be described.

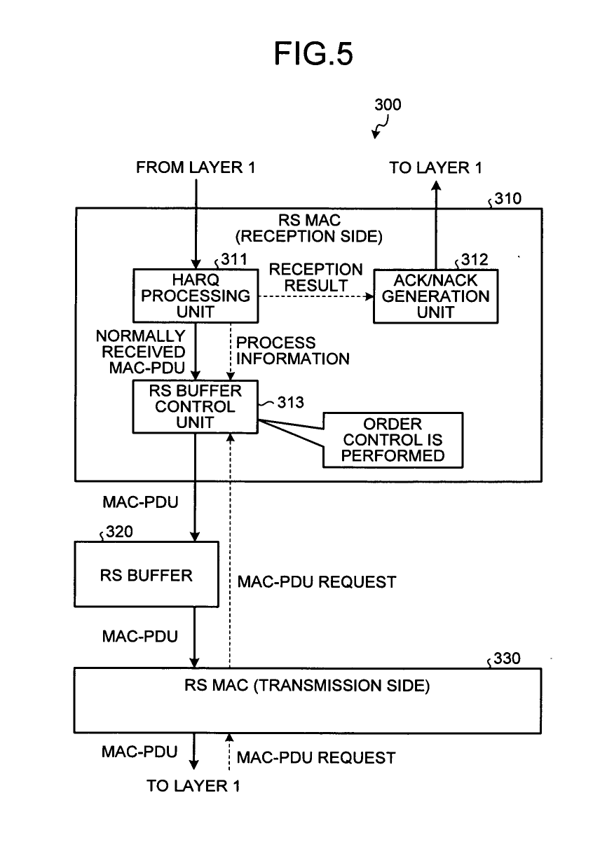

As illustrated in FIG. 5, the RS 300 according to the second embodiment includes an RS MAC 310, at the reception side, that receives data from the eNB 100 as a first communication device through the layer 1, an RS MAC 330, at the transmission side, that transmits data received from the eNB 100 to the UE 200 as a second communication device, and an RS buffer 320 that temporarily stores data received from the eNB 100 for retransmission of data to the UE 200 to be performed by the RS MAC 330 at the transmission side.

As illustrated in FIG. 5, the RS MAC 310 at the reception side includes a HARQ processing unit 311 and an ACK/NACK generation unit 312, similarly to the MAC 210 of the first embodiment. The HARQ processing unit 311 functions as a data reception unit that receives data, which is transmitted from the eNB 100 in a predetermined order, through the layer 1.

The ACK/NACK generation unit 312 transmits ACK to the eNB 100 when the HARQ processing unit 311 has successfully received data and transmits NACK to the eNB 100 when the HARQ processing unit 311 has failed to receive data.

The RS MAC 310 includes an RS buffer control unit 313 that stores data received by the HARQ processing unit 311 in the RS buffer 320 in a reception order. Further, when data that has failed to be received by the HARQ processing unit 311 (that the error detection result using the CRC code has indicated “unsuccessful reception”) is retransmitted from the eNB 100 and then the HARQ processing unit 311 successfully receives the retransmitted retransmission data (the error detection result using the CRC code indicates “successful reception”), the RS buffer control unit 313 performs order control so that the storage order of data in the MAC buffer 213 can be rearranged according to the predetermined order in which the eNB 100 has first performed transmission by storing the retransmission data in the RS buffer 320 as data received in the predetermined order in which the eNB 100 has first performed transmission, based on the process information of data that has successfully been received.

Similarly to the case in which the MAC 210 of the first embodiment performs the order control on the storage order of data in the MAC buffer 213 based on the process information of data, at each time when the HARQ processing unit 311 receives data, the RS buffer control unit 313 acquires and stores the process information corresponding to the data from the HARQ processing unit 311.

Further, when data retransmitted from the eNB 100 is received, similarly to the MAC 210 of the first embodiment, the RS buffer control unit 313 rearranges the storage order of data inside the RS buffer 320 according to the predetermined order in which the eNB 100 has first performed transmission based on the process information of the retransmission data and the previously stored process information.

Further, when a MAC-PDU request transmitted from the RS MAC 330 at the transmission side is received, the RS buffer control unit 313 transmits data, which has been changed in the storage order and stored in the RS buffer 320, to the UE 200 through the RS MAC 330 at the transmission side and the layer 1.

By constituting the RS 300 as described above, in the UE 200 that receives data from the eNB 100 through the RS 300, the processing load occurring that in the RLC 220 rearranges data is reduced, so that a data transmission time from the eNB 100 to the UE 200 can be reduced.

Further, similarly to the MAC 210 of the first embodiment, even the RS 300 may be configured to rearrange the storage order of data in the RS buffer 320 according to the transmission order of data of the eNB 100 based on the number of retransmission times and the process number of the received retransmission data instead of the process information.

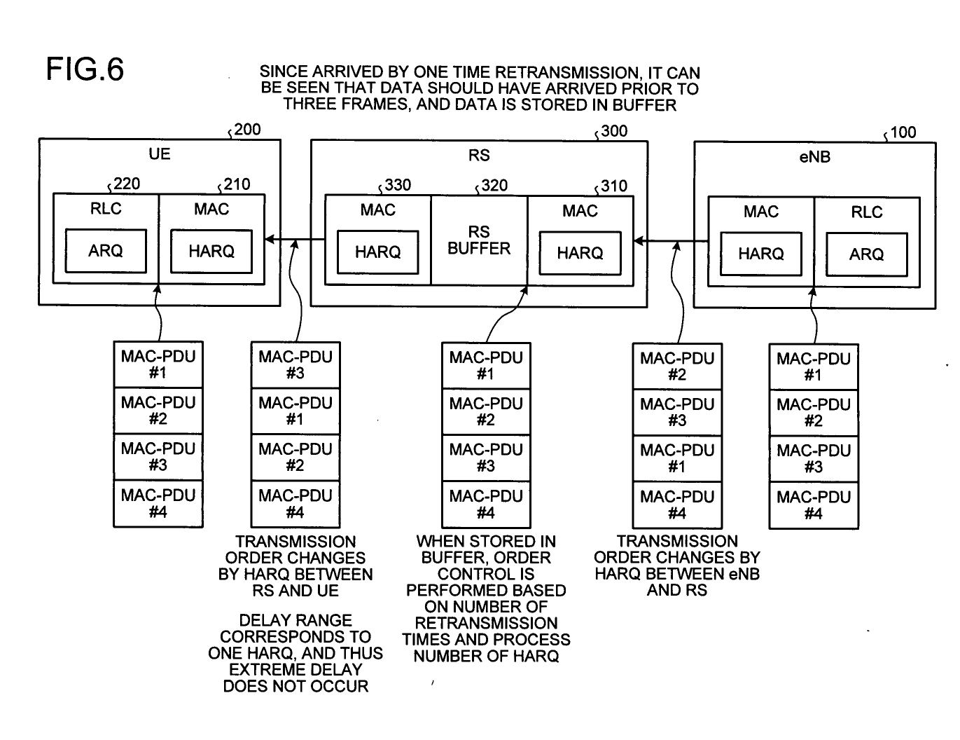

FIG. 6 is an explanation diagram illustrating the flow of data when the UE 200 receives data from the eNB 100 through the RS 300 according to the second embodiment. In FIG. 6, the UE 200 that receives data has the same configuration as the UE 200 of the first embodiment, but the PDCP 230 is omitted. Even in FIG. 6, in order to discriminate each data (MAC-PDU), for convenience, each data is labeled as a number (#1, #2, etc.).

As illustrated in FIG. 6, when data is transmitted in an order of #1, #2, #3, and #4 from the eNB 100, due to automatic retransmission control performed by each HARQ between the eNB 100 and the RS 300, the HARQ processing unit 311 of the RS 300 receives data in a reception order (here, an order of #2, #3, #1, and #4) different from a transmission order of data of the eNB 100.

However, in the RS 300 of the second embodiment, the RS buffer control unit 313 in the RS MAC 310 at the reception side rearranges an order of data received by the HARQ processing unit 311 and then stores the data in the RS buffer 320. Thus, the data is stored in the RS buffer 320 in the transmission order of data of the eNB 100, that is, an order of #1, #2, #3, and #4. Further, the RS buffer control unit 313 performs the order control based on the number of retransmission times and the process number of the retransmission data.

Thereafter, data stored in the RS buffer 320 is transmitted to the UE 200. Here, due to automatic retransmission control performed by each HARQ between the RS 300 and the UE 200, the HARQ processing unit 211 of the UE 200 receives data in a reception order (here, an order of #3, #1, #2, and #4) different from a transmission order of data of the eNB 100.

However, the MAC buffer control unit 215 of the UE 200 rearranges the storage order of data received by the HARQ processing unit 211 and then stores the data in the MAC buffer 213. Thus, when data is transmitted from the MAC buffer 213 to the RLC 220 that is the upper-level layer, the data is transmitted in the transmission order of data of the eNB 100, that is, an order of #1, #2, #3, and #4.

As described above, when the RS 300 is disposed between the eNB 100 and the UE 200, the automatic retransmission control is performed twice by the HARQ between the eNB 100 and the RS 300 and between the RS 300 and the UE 200. However, by disposing the RS buffer control unit 313 in the RS MAC 310 as in the RS 300 of the second embodiment, the MAC buffer control unit 215 of the UE 200 can complete the order control by performing the order control on the reception order of data changed by the automatic retransmission control between the RS 300 and the UE 200.

In the UE 200 that receives data from the eNB 100 through the RS 300, since the processing load occurring when the RLC 220 rearranges data is reduced as much as one time automatic retransmission control performed by the HARQ, a data transmission time from the eNB 100 to the UE 200 can be reduced.

Further, in the RS 300, when a predetermined time elapses since the reception side HARQ processing unit 311 has received data, regardless of whether or not the order control is performed so that the storage order of data in the RS buffer 320 can be changed to a predetermined transmission order of the eNB 100, the RS buffer control unit 313 transmits each data stored in the RS buffer 320 to the RS MAC 330 at the transmission side.

However, in view of the maximum number of retransmission times of data by the eNB 100, a time until at least data that has failed to be received is transmitted the maximum number of retransmission times is used as the predetermined time, and the RS buffer control unit 313 is configured to transmit each data stored in the RS buffer 320 to the RS MAC 330 at the transmission side when the predetermined time elapses.

As a result, since a time required for the storage order control of data performed by the RS buffer control unit 313 does not unnecessarily increase, the data transmission efficiency can be prevented from deteriorating.

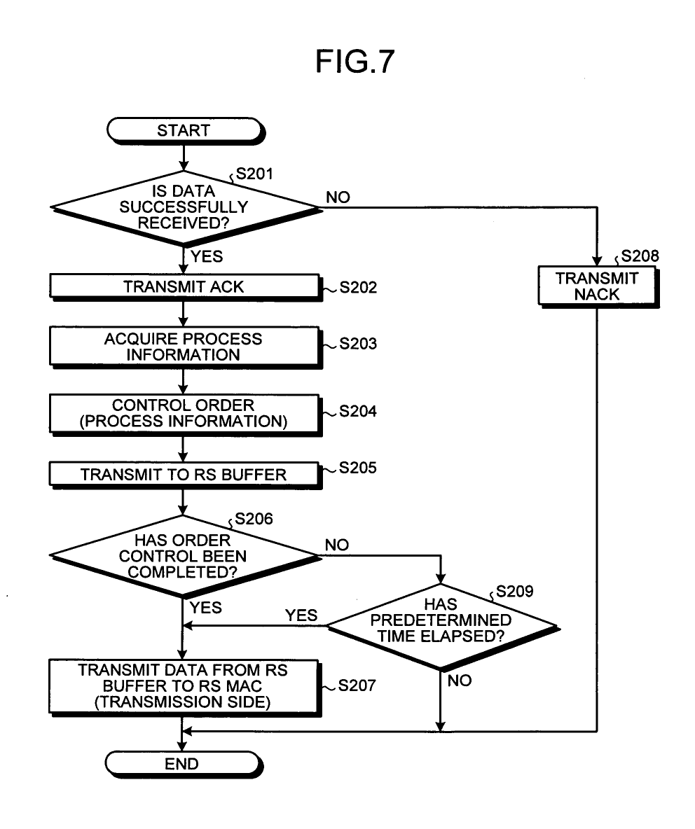

Here, a process to be executed in the RS MAC 310 at the reception side will be described with reference to FIG. 7 in connection with a case in which the RS buffer control unit 313 performs the order control on the storage order of data in the RS buffer 320 based on the process information of data successfully received by the HARQ processing unit 311. Each process described below is a process implemented such that a CPU of a computer disposed in the RS 300 reads out a communication program according to the present embodiment from a ROM and executes the communication program using a RAM as a working area.

When data is transmitted from the eNB 100, as illustrated in FIG. 7, the RS MAC 310 determines whether or not the HARQ processing unit 311 has successfully received data (step S201). When it is determined that reception has been failed (No in step S201), the ACK/NACK generation unit 312 transmits NACK to the eNB 100 (step S208), and the process is finished.

However, when it is determined that the HARQ processing unit 311 has successfully received data (Yes in step S201), the ACK/NACK generation unit 312 transmits ACK to the eNB 100 (step S202), and then the RS buffer control unit 313 acquires and stores the process information of data successfully received from the HARQ processing unit 311 (step S203).

Next, the RS buffer control unit 313 determines a first transmission order of the eNB 100 on data successfully received this time based on the previously stored process information and the process information acquired this time and performs the order control so that the storage order of data in the RS buffer 320 can be changed to the transmission order in which the eNB 100 has first performed transmission (step S204). Thereafter, data is transmitted to the RS buffer 320 (step S205).

Here, the RS buffer control unit 313 determines whether or not the order control has been completed (step S206). At this time, when the storage order of data stored in the MAC buffer 213 is changed to a predetermined transmission order in which the transmission eNB 100 has first performed transmission, the RS buffer control unit 313 determines that the order control has been completed.

Then, when it is determined that the order control has been completed (Yes in step S206), if the MAC-PDU request is received from the RS MAC 330 at the transmission side, the RS buffer control unit 313 transmits data stored in the RS buffer 320 to the RS MAC 330 at the transmission side (step S207), and the process is finished. Thereafter, data transmitted to the transmission side RS MAC 330 is transmitted to the UE 200.

However, when it is determined in step S206 that the order control has not been completed (No in step S206), the RS buffer control unit 313 determines whether or not a predetermined time has elapsed (step S209). Here, if data successfully received this time is retransmission data, the RS buffer control unit 313 determines whether or not a predetermined time has elapsed since first reception of the data has failed. However, if data successfully received this time is not retransmission data, the RS buffer control unit 313 determines whether or not a predetermined time has elapsed since data has been received.

Then, when it is determined that the predetermined time has elapsed (Yes in step S209), if the MAC-PDU request is received from the RS MAC 330 at the transmission side, the RS buffer control unit 313 transmits data stored in the RS buffer 320 to the RS MAC 330 at the transmission side (step S207), and the process is finished. Thereafter, data transmitted to the transmission side RS MAC 330 is transmitted to the UE 200. However, when it is determined that the predetermined time has not elapsed (No in step S209), the RS buffer control unit 313 finishes the process “as is”.

Further, when the RS buffer control unit 313 performs the order control on the storage order of data in the RS buffer 320 based on the number of retransmission times and the process information of data successfully received by the reception side HARQ 211, the RS buffer control unit 313 executes a process of acquiring the number of retransmission times of data successfully received this time instead of the process of step S203 (process information acquisition) in FIG. 7.

In this case, after acquiring the number of retransmission times, similarly to step S104 illustrated in FIG. 4, the RS buffer control unit 313 determines whether or not the number of retransmission times is zero (0). If the retransmission times is zero (0), the process proceeds to step 5205, and data received this time is transmitted to the RS buffer 320.

However, If the retransmission times is not zero (0), the process proceeds to step S204, and the RS buffer control unit 313 performs the order control of data in the RS buffer 320. Here, the RS buffer control unit 313 multiplies the number of retransmission times by the process number to decide the storage order of data successfully received this time. Thereafter, the RS buffer control unit 313 executes the process subsequent to step S205.

As described above, in the RS 300 of the second embodiment, when data retransmitted from the eNB 100 is successfully received, the RS buffer control unit 313 rearranges the storage order of data in the RS buffer 320 according to the predetermined order in which the eNB 100 has first performed transmission based on the process information of the data or the number of retransmission times and the process number of the data. Thus, in the UE 200 that receives data relayed by the RS 300, the processing load occurring when the RLC 220 rearranges data is reduced.

According to an embodiment of the present invention, since a reception order of data received by the lower-layer is rearranged in advance before the data is transmitted to the upper-level layer, when a communication device with a communication protocol including a plurality of layers receives data from another communication device, the processing load occurring when the upper-level layer performs reception order control on data received through the lower-level layer can be reduced, and an unnecessary retransmission request can be prevented from being made.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device with a communication protocol including at least two layers, comprising:
a data reception unit that receives data transmitted from another communication device;
a buffer control unit that rearranges a storage order of data in a buffer based on a number of retransmission times and a retransmission interval of retransmission data, stores the retransmission data in the buffer when the data reception unit has successfully received the retransmitted retransmission data; and
a data transfer unit that transfers the data stored in the buffer to an upper layer.

2. The communication device according to claim 1, wherein the buffer control unit stores process information, which represents the sequence number of data that has failed to be received, determined based on a failure timing when the data has failed to be received by the data reception unit, and rearranges the storage order of the retransmission data according to an order of process number based on process information determined based on a reception success timing and previously stored process information when the data that has failed to be received is retransmitted from the another communication device and when the data reception unit has successfully received the retransmitted retransmission data.

3. The communication device according to claim 1, wherein the data transfer unit transfers the data when a predetermined time elapses since the data reception unit has received the data.

4. A communication device that relays data between communication devices, comprising:
a data reception unit that receives data including a sequence number transmitted from a first communication device;
a data transmission unit that replies, to the first communication device, whether or not the data reception unit has successfully received data;
a relay buffer control unit that stores the data received by the data reception unit in a predetermined relay buffer, and rearranges a storage order of data in the relay buffer according to an order of the sequence number by storing retransmission data in the relay buffer as data received in the order of the sequence number when data that has failed to be received by the data reception unit is retransmitted from the first communication device and when the data reception unit has successfully received the retransmitted retransmission data; and
a data transfer unit that transfers the data stored in the relay buffer to a second communication device.

5. The communication device according to claim 4, wherein the relay buffer control unit rearranges the storage order of the retransmission data according to the order of the sequence number based on a number of retransmission times and a retransmission interval of the retransmission data.

6. The communication device according to claim 4, wherein the relay buffer control unit stores process information, which represents the sequence number of data that has failed to be received, determined based on a failure timing when the data has failed to be received by the data reception unit, and rearranges the storage order of the retransmission data according to an order of the sequence number based on process information determined based on a reception success timing and previously stored process information when the data that has failed to be received is retransmitted from the first communication device and when the data reception unit has successfully received the retransmitted retransmission data.

7. The communication device according to claim 4, wherein the data transfer unit transfers the data when a predetermined time elapses since the data reception unit has received the data.

8. A communication method performed in a communication device with a communication protocol including at least two layers, the method comprising causing a computer as a lower layer to execute:
receiving data transmitted from another communication device;
rearranging a storage order of data in a buffer based on a number of retransmission times and a retransmission interval of retransmission data and storing the retransmission data in the buffer when the retransmitted retransmission data has successfully been received; and
transferring data stored in the buffer to an upper layer.

9. A communication method performed in a communication device that relays data between communication devices, the method comprising causing a computer as the communication device to execute:
receiving data including a sequence number transmitted from a first communication device;
storing the received data in a relay buffer;
replying, to the first communication device, whether or not data has successfully been received;
rearranging a storage order of data in the relay buffer according to an order of the sequence number by storing retransmission data in the relay buffer as data received in the order of the sequence number when data that has failed to be received is retransmitted by the first communication device and when the retransmitted retransmission data has successfully been received; and
transferring data stored in the relay buffer to a second communication device.

10. A computer-readable, non-transitory medium storing a communication program executed in a communication device with a communication protocol including at least two layers, the communication program causing a computer as a lower layer to execute a process comprising:
receiving data including a sequence number transmitted from another communication device;
storing received data in a buffer;
replying, to the another communication device, whether or not data has successfully been received;
rearranging a storage order of data in the buffer according to an order of the sequence number by storing retransmission data as data received in the order of the sequence number when data that has failed to be received is retransmitted from the another communication device and when the retransmitted retransmission data has successfully been received; and
transferring data stored in the buffer to an upper layer.
